(19) United States
(12) Patent Application Publication
(10) Pub. No.: US 2012/0293474 A1
(43) Pub. Date: Nov. 22, 2012

(54) SYSTEMS AND METHODS FOR FACILITATING LIFT-OFF PROCESSES

(75) Inventors: I-Shan Sun, San Jose, CA (US); Francois Hebert, San Mateo, CA (US); Rick Carlton Jerome, Indialantic, FL (US)

(73) Assignee: INTERSIL AMERICAS INC., Milpitas, CA (US)

(21) Appl. No.: 13/233,667

(22) Filed: Sep. 15, 2011

Related U.S. Application Data
(60) Provisional application No. 61/487,353, filed on May 18, 2011.

(51) Int. Cl. G09G 5/10; B05D 1/36; B05D 5/06; G01J 1/42; G01J 1/02

(52) U.S. Cl. 345/207; 250/214 AL; 250/200; 427/162; 427/163.1

(57) ABSTRACT

Systems and methods for facilitating lift-off processes are provided. In one embodiment, a method for pattering a thin film on a substrate comprises: depositing a first sacrificial layer of photoresist material onto a substrate such that one or more regions of the substrate are exposed through the first sacrificial layer; depositing a protective layer over at least part of the first sacrificial layer; partially removing the first sacrificial layer to form at least one gap between the protective layer and the substrate; depositing an optical coating over the protective layer and the one or more regions of the substrate exposed through the first sacrificial layer, wherein the optical coating deposited over the protective layer is separated by the at least one gap from the optical coating deposited over the regions of the substrate exposed through the first sacrificial layer; and removing the first sacrificial layer.

### CROSS REFERENCE TO RELATED APPLICATIONS

This application claims priority to and the benefit of U.S. Provisional Application No. 61/487,353 entitled “SYSTEMS AND METHODS FOR FACILITATING LIFT-OFF PROCESSES” and filed on May 18, 2011, which in its entirety is incorporated herein by reference.

### DRAWINGS

Embodiments of the present invention can be more easily understood and further advantages and uses thereof more readily apparent, when considered in view of the description of the preferred embodiments and the following figures in which:

FIG. 1 illustrates a device formed during the performance of a lift-off process according to one embodiment;

FIG. 2a-2d are illustrations of the fabrication of a device using a lift-off process according to one embodiment;

FIG. 3a-3d are illustrations of the fabrication of a device using a lift-off process according to one embodiment; and

FIG. 4 is a flow diagram of a method for performing a lift off process according to one embodiment.

FIG. 5a is a diagram illustrating a device according to one embodiment;

FIG. 5b is a diagram illustrating a system comprising the device of FIG. 5a according to one embodiment; and

FIG. 6 is a diagram illustrating a system according to one embodiment.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Ambient light sensors, proximity sensors, and other optical sensing applications use high performance optical filters that have tailored spectrum response. For example, an optical filter coating can be used to achieve a sensor that has a true human eye response. To achieve the desired spectrum response, optical filters in the form of dielectric mirrors are created by stacking layers of dielectric films patterned on top of a substrate. The dielectric films are applied by sputtering, deposition or evaporation methods. This is followed by patterning of the stacked dielectric films using a lift-off process. One or more embodiments of the present invention disclosed herein combine the use of an undercut sacrificial layer with a protective layer to create physical gaps in optical coatings of the dielectric film. These gaps, as explained in detail below, are readily utilized to release the sacrificial layer from the substrate, substantially simplifying the lift-off process for optical coatings. A protective layer, as referred to herein, is a non-photoresist material that can be deposited on top of a sacrificial layer of photoresist material at a sufficiently low temperature so as to avoid causing reflow of the photoresist material used in the sacrificial layer. Examples of such a non-photoresist material would include an Oxide (such as SiO₂) but can also include other materials such as, but not necessarily limited to, SiON, SiN, Si₃N₄, Si, as well as some metal layers such as Ti, TiN, TiW, Al, Ni, and Au. Also as further discussed below, for some applications a protective layer is formed from an initial few layers of optical coating material applied such that the sacrificial layer does not reach a temperature that will cause it to flow.

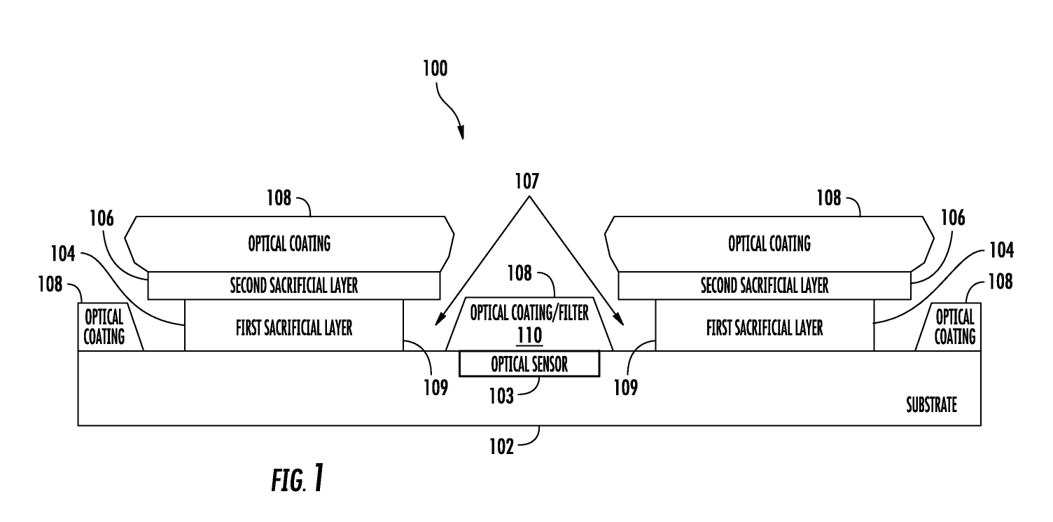

FIG. 1 is a block diagram generally at 100 illustrating a protected-resist lift-off process of one embodiment of the present invention. In this embodiment, the process is performed on a substrate 102 that includes one or more active devices including at least one optical sensor 103. As the term is used through-out this specification, an optical sensor is any device that performs its function at least partially based on light it deceives. One example of such an optical sensor is a photo-diode. Other examples include image capturing devices and proximity sensors. Such optical sensors may operate using any portion of the optical spectrum including wavelengths visible and/or not-visible to an unaided human eye. The process described with respect to FIG. 1 provides substrate 102 with a patterned layer of an optical coating (illustrated by layer 108) in order to filter the spectrum of light waves received by optical sensor 103.

A first sacrificial layer 104 is applied in a pattern over those regions of the substrate 102 where an optical coating is not desired. The pattern leaves exposed those regions of substrate 102 where an optical coating is desired. In one embodiment, the first sacrificial layer 104 is a layer of photoresist applied using masking with a spin or sputtering process, for example. At the high temperatures used to deposit optical coatings (125 Celsius, for example) photoresist will begin to flow. A benefit of the protected-resist lift-off process illustrated by FIG. 1 is that the photoresist will not lose its desired masking pattern. Further, when an optical coating (which in some embodiments will be from 2 to 9 microns thick) is applied directly over the photoresist, formation of a conformal layer by the optical coating (which makes lift-off very difficult) is avoided. That is, application of such an optical coating using this process will avoid encapsulation of the photoresist, providing for access that aids removal of that layer during lift-off.

Instead, a second sacrificial layer 106 of material is applied over the first sacrificial layer 104. In one embodiment, the second sacrificial layer comprises a low temperature deposited oxide or other non-photoresist protective layer material as discusses above. The second sacrificial layer 106 performs two functions. First, it provides a protective layer that thermally shields the first sacrificial layer 104 during application of the optical coating 108. Doing so, it increases the thermal budget so that the first sacrificial layer 104 will maintain its profile for a longer period of time. Second, it permits further lateral undercutting of the first sacrificial layer 104 prior to application of the optical coating 108. As used herein, the term undercutting refers to the partial removal of sacrificial material. For example, in one embodiment, undercutting of first sacrificial layer 104 comprises removal of approximately 1 μm around the edges of first sacrificial layer 104. This lateral undercutting of first sacrificial layer 104 produces an open void or gap (shown at 107 between the second sacrificial layer 106 and the substrate 102) that will remain open to expose the sidewalls 109 of the first sacrificial layer 104 even after the optical coating 108 is applied.

In one embodiment, after the second sacrificial layer 106 is applied, a masking layer is applied over the second sacrificial layer 106 and a pattern is etched into the masking layer to expose the region of substrate 102 having sensor 103 onto which the optical coating 108 is applied. This also exposes sidewalls of the first sacrificial layer 104 to permit the lateral undercutting. Once the pattern is developed through to expose sensor 103 and the first bottom layer 104, the masking layer is removed.

Those portions of optical coating 108 applied over the second sacrificial layer 106 are removed when the first sacrificial layer 104 is removed during the lift-off process. Those portions of optical coating 108 applied to the exposed optical sensor 103 will remain to function as an optical filter (show generally at 110). In order to perform the lift-off process, an etchant or solvent solution is applied which enters into the gaps 107 to attack and destroy sacrificial layer 104. Those portions of the second sacrificial layer 106 and the optical coating 108 supported by the first sacrificial layer 104 will rinse or break away in this process.

Rather than being a uniform layer of material, an optical coating actually comprises multiple dielectric layers individually applied over several hours. For example, a finished optical coating 108 may comprise 70 layers of deposited dielectric films. In one embodiment, the thickness of each layer is on the order of 100 nm. Because gaps 107 provide a well defined break, the lift-off procedure applied in the embodiment of FIG. 1 will not distort edges of the layers of deposited dielectric films forming optical filter 110. That is, the dielectric layers forming optical filter 110 will remain substantially flat so that the horizontal surfaces of those layers form parallel planes with respect to each other across optical filter 110 and the surface of substrate 102 to which they were applied. This is described further with respect to FIG. 5a.

The specific compositions and combinations of these multiple dielectric layers dictate the refraction index of the optical filter 110. Such stacks of various dielectric films are generally referred to as dielectric mirrors. Selection of dielectric material will depend both on the wavelengths of light to be filtered from reaching sensor 103. For example, in one embodiment, optical filter 110 comprises a dielectric mirror of alternating silicon and silicon-dioxide layers.

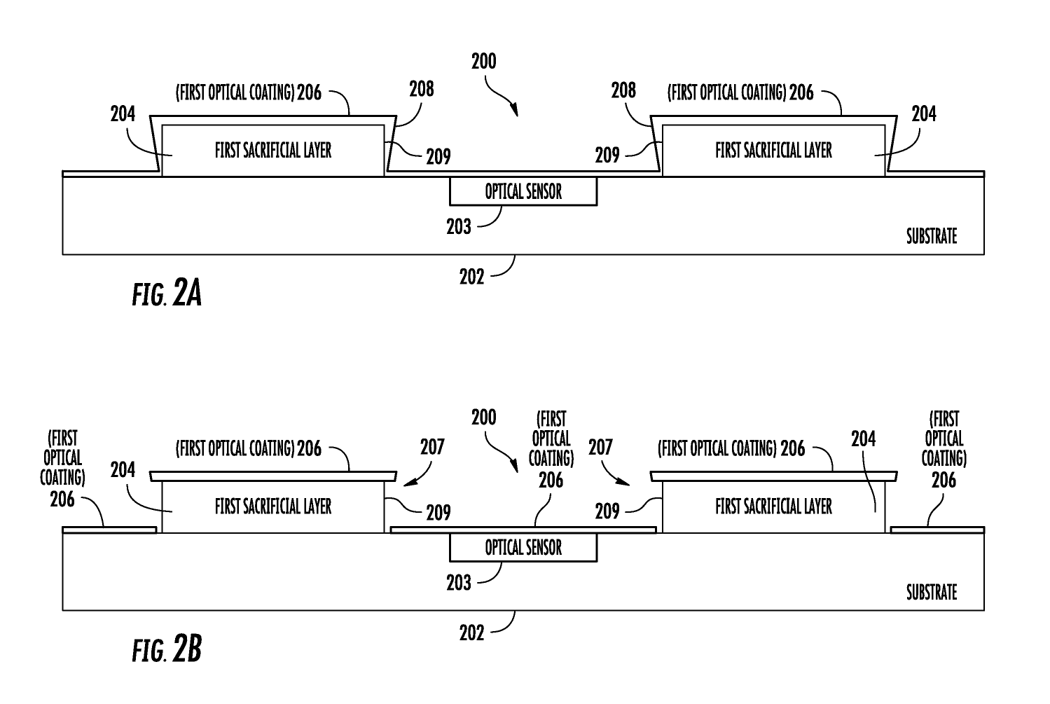

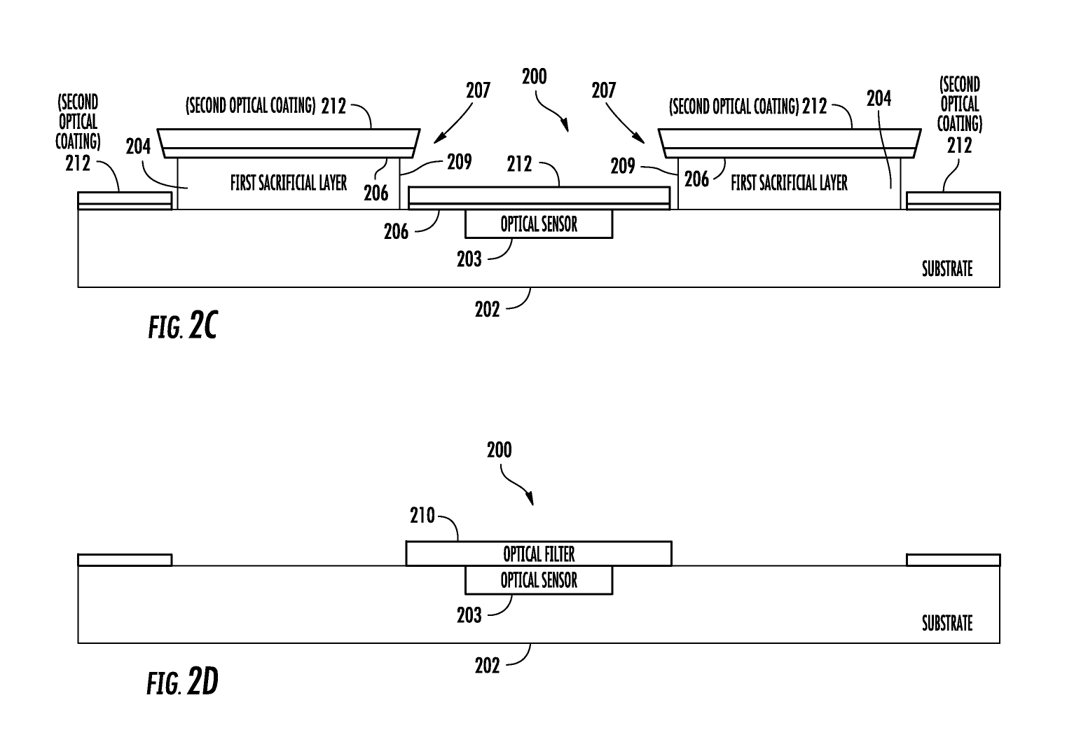

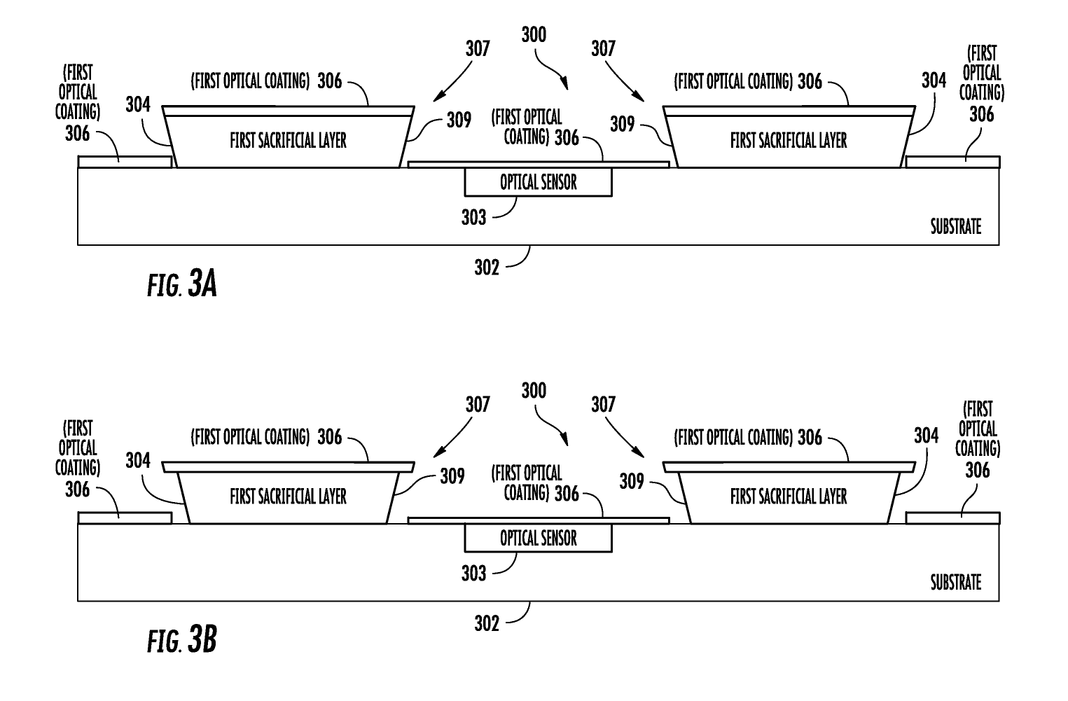

FIGS. 2a-2d are block diagrams illustrating another embodiment of a process using a two-step application of optical coating material. Referring first to FIG. 2a, the process of this embodiment is performed on a substrate 202 that includes one or more active devices including at least one optical sensor 203. One example of such a device is a photo-diode.

A first sacrificial layer 204 is applied in a pattern over those regions of the substrate 202 where the optical coating is not desired. In one embodiment, the first sacrificial layer 204 is a patterned layer of photoresist applied using masking with a spin or sputtering process, for example. First sacrificial layer 204 forms a pattern that permits the deposition of dielectric material on the regions of substrate 202 where optical filters are needed. For example, in one embodiment, first sacrificial layer 204 forms a pattern leaving optical sensor 203 exposed so that an optical coating can be deposited.

As mentioned above, deposition of optical coatings typically is performed over several hours at high temperatures (125 Celsius, for example) that will cause photoresist material to flow. The optical film material is applied as multiple interleaved dielectric layers that form a stack of films referred to as a dielectric mirror. By alternating materials with different dielectric characteristics, a dielectric mirror having the desired refraction index to pass certain wavelengths of light is produced. Such dielectric mirrors thus function as optical filters for optical devices such as optical sensor 203. In the embodiment of FIGS. 2a-d, instead of depositing a second sacrificial layer as is done in the embodiment of FIG. 1, a two-step application of optical film material is utilized to avoid flow of the photoresist.

As illustrated in FIG. 2a, a first optical coating 206 is deposited over the photoresist of first sacrificial layer 204 and over the exposed regions of substrate 202, including the surface of optical sensor 203. The first optical coating 206 comprises a sufficiently small number of dielectric layers such that when they are applied, the first sacrificial layer 204 does not reach a temperature that will cause it to flow. For example, in one embodiment deposition of only a first few layers of optical film material prevents a sputtering system depositing the material from heating up and flowing the photoresist pattern of first sacrificial layer 204. In one embodiment, first optical coating 206 comprises only 2-4 layers of optical coating material such that a first sacrificial layer 204 of photoresist does not reach its flow temperature of 125 Celsius. In addition, the first optical coating 206 is applied to a thickness less than that of the first sacrificial layer 204. For example, in one embodiment the first sacrificial layer 204 comprises a photoresist layer of 1-10 micrometers while the first optical coating 206 is between 200-400 nanometers in thickness.

When the first optical coating 206 is applied, a slight non-conformity of sputtered films will result in a thinner layer of optical film material (shown generally at 208) on the sidewalls 209 of first sacrificial layer 204. Applying an ultra sonic rinse will break down these areas of relatively thin optical film exposing the sidewalls 209 of first sacrificial layer 204, shown in FIG. 2b. In one embodiment, application of the ultra sonic rinse creates micro-cracks which allow etching solutions to penetrate to reach sidewalls 209. Sidewalls 209 are then further undercut (on the order of 1-10 micron) to produce gaps 207 between the first optical coating 206 and substrate 202. In one embodiment, a wet etch is applied to achieve the undercut and produce gaps 207.

Next, as illustrated in FIG. 2c, a second optical coating 212 is deposited over the first optical coating 206. Like the second sacrificial layer 106 discussed in FIG. 1, the first optical coating 206 serves as a protective layer that at least partially thermally shields the first sacrificial layer 204 during application of the second optical coating 212. Doing so, it increases the thermal budget so that the first sacrificial layer 204 will maintain its profile for a longer period of time. Second, the first optical coating 206 permits further lateral undercutting of the first sacrificial layer 204 prior to application of the second optical coating 212. The lateral undercutting produces the gaps 207 that will remain open to expose the sidewalls 209 of the first sacrificial layer 204 even after the second optical coating 212 is applied. That is, the continued deposition of the remaining optical films will not deposit onto sidewalls 209 or fill gaps 207 due to non-conformality. When the layers of the optical coating 212 are applied over the initial layers of optical coating 206, a physical break remains between those portions of optical coatings 206 and 212 applied to the first sacrificial layer 204 and those portions of optical coatings 206 and 212 applied over the exposed optical sensor 203.

Referring to FIG. 2d, those portions of optical coatings 206 and 212 applied over the first sacrificial layer 204 are removed when the first sacrificial layer 204 is removed by the lift-off process. In one embodiment, an ultrasonic rinse is applied through gaps 207 to laterally etch and completely remove the sacrificial layer 204 in order to “lift-off” the optical coatings 206 and 212 present on top of the sacrificial layer 204. In another embodiment, an etchant or solvent solution is applied which enters into the gaps 207 to attack and destroy sacrificial layer 204. Those portions of the first and second optical coatings 206 and 212 supported by the first sacrificial layer 204 will rinse or break away in this process. Those portions of the first and second optical coatings 206 and 212 applied to the exposed substrate 202 will remain. For example, those portions of the first and second optical coatings 206 and 212 applied to the exposed optical sensor 203 will remain to function as an optical filter (show at 210) for optical sensor 203.

Because gaps 207 provide a well defined break, the lift-off procedure applied to remove the first sacrificial layer 204 does not distort edges of the layers of deposited dielectric films forming optical filter 210. Instead, the dielectric layers forming optical filter 210 are substantially flat across optical filter 110 because they have not been deformed by the lift-off process. This is described further with respect to FIG. 5a.

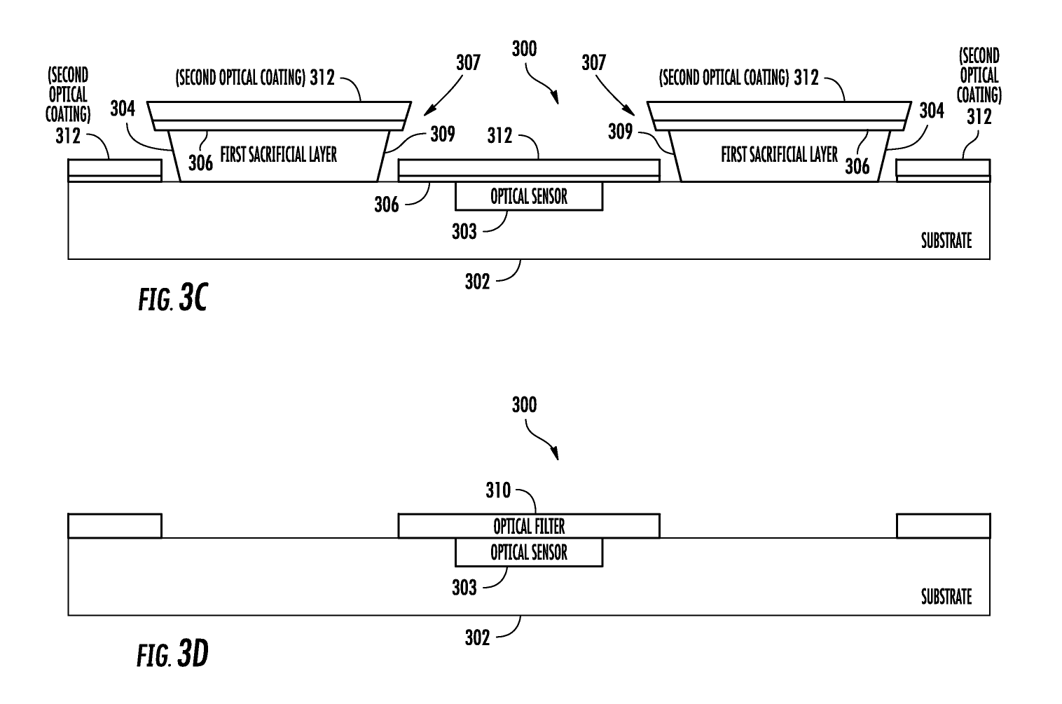

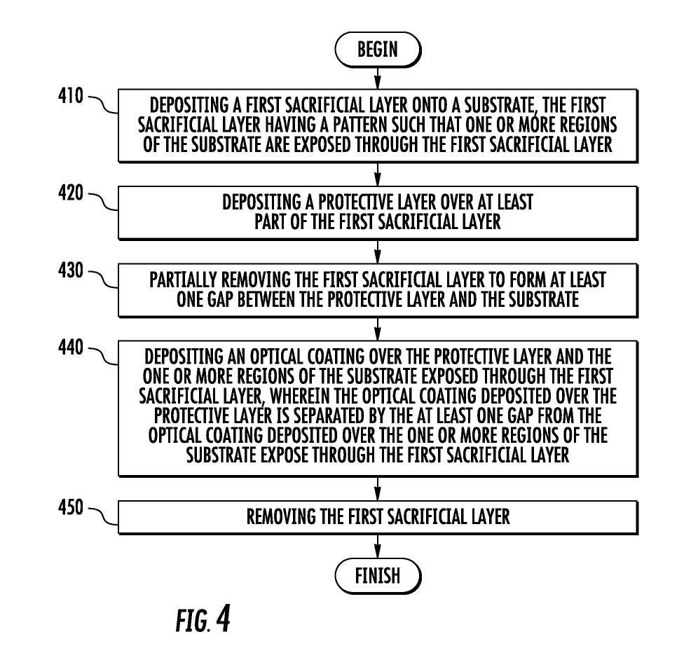

FIGS. 3a-3d are block diagrams illustrating another embodiment of a process for providing an optical filter for an optical sensor using a double-coating lift-off process of one embodiment of the present invention. Referring first to FIG. 3a, the process of this embodiment is performed on a substrate 302 that includes one or more active devices including at least one optical sensor 303. Using this process, substrate 302 is provided with a patterned layer of an optical coating to filter light received by optical sensor 303.

A first sacrificial layer 304 is applied to cover those regions of the substrate 302 where the optical coating is not desired. In one embodiment, the first sacrificial layer 304 is a patterned layer of photoresist applied using masking with a spin or sputtering process, for example. The first sacrificial layer 304 forms a pattern that permits the deposition of dielectric material on the regions of substrate 302 where optical filters are needed. For example, in one embodiment first sacrificial layer 304 forms a pattern leaving optical sensor 303 exposed so that an optical coating can be deposited. In addition, in this embodiment an etching process is applied that provides a negatively angled re-entrant profile on the sidewalls 309 of the first sacrificial layer 304. That is, sidewalls 309 have a re-entrantly sloped profile, which is wider at the top than at the bottom. In one embodiment, the slope of each of the sidewalls 309 is less than 88 degrees from a normal (i.e. a vertical 90 degree) slope. As with the embodiment of FIGS. 2a-d, a two-step application of optical film material is utilized to avoid flow of the photoresist. A protective layer comprising a first optical coating 306 is deposited over the first sacrificial layer 304 and over the exposed regions of substrate 302, including the surface of optical sensor 303. The first optical coating 306 comprises a sufficiently small number of dielectric layers such that when they are applied, the first sacrificial layer 304 does not reach a temperature that will cause it to flow. Further, the first optical coating 306 is applied at a temperature that will preserve the negatively angled re-entrant profile of sidewalls 309. In one embodiment, first optical coating 306 comprises 2-4 layers, each on the order of 100 nanometers thick, applied such that the first sacrificial layer 304 does not reach its reflow temperature. In addition, the first optical coating 306 is applied to a total thickness that less than the thickness of the first sacrificial layer 304. For example, in one embodiment the first sacrificial layer 304 comprises a photoresist layer of 1-10 micrometers while the first optical coating 306 is between 200-400 nanometers in thickness.

Because the sidewalls 309 were provided with a negatively angled re-entrant profile, application of the first optical coating 306 will not result in a coating of optical film material on the sidewalls 309. That is, the profile of sidewalls 309 will prevent the optical film material from being deposited on the re-entrant slope of the photoresist sidewalls.

The exposed sidewalls 309 are further undercut (on the order of 1-10 micron) to produce gaps 307 between the first optical coating 306 and substrate 302. In one embodiment, a wet etch is applied to achieve the undercut and produce gaps 307.

Next, as illustrated in FIG. 3c, a second optical coating 312 is deposited over the first optical coating 306. As described with the embodiments above, the first optical coating 306 serves as a protective layer that at least partially thermally shields the first sacrificial layer 304 during application of the second optical coating 312. Doing so, it increases the thermal budget so that the first sacrificial layer 304 will maintain its profile for a longer period of time. Second, the first optical coating 306 permits further lateral undercutting of the first sacrificial layer 304 prior to application of the second optical coating 312. The lateral undercutting produces the gaps 307 that will remain open to expose the sidewalls 309 of the first sacrificial layer 304 even after the second optical coating 312 is applied. That is, the continued deposition of the remaining optical films will not deposit onto sidewalls 309 or fill gaps 307 due to non-conformality. When the layers of the optical coating 312 are applied over the initial layers of optical coating 306, a physical break remains between those portions of optical coatings 306 and 312 applied to the first sacrificial layer 304 and those portions of optical coatings 306 and 312 applied over the exposed optical sensor 303.

Referring to FIG. 3d, those portions of optical coatings 306 and 312 applied over the first sacrificial layer 304 are removed when the first sacrificial layer 304 is removed during the lift-off process.

In one embodiment, an ultrasonic rinse is applied through gaps 307 to laterally etch and completely remove the sacrificial layer 304 in order to “lift-off” the optical coatings 306 and 312 present on top of the sacrificial layer 304. In another embodiment, an etchant or solvent solution is applied which enters into the gaps 307 to attack and destroy sacrificial layer 304. Those portions of the first and second optical coatings 306 and 312 supported by the first sacrificial layer 304 will rinse or break away in this process. Those portions of the first and second optical coatings 306 and 312 applied to the exposed substrate 302 will remain. For example, those portions of the first and second optical coatings 306 and 312 applied to the exposed optical sensor 303 will remain to function as an optical filter (show generally at 310) for optical sensor 303.

Because gaps 307 provide a well defined break, the lift-off procedure applied to remove the first sacrificial layer 304 does not distort edges of the layers of deposited dielectric films forming optical filter 310. Instead, the dielectric layers forming optical filter 310 have horizontal surfaces that are substantially flat parallel planes across optical filter 310 because they have not been deformed by the lift-off process. This is described further with respect to FIG. 5a.

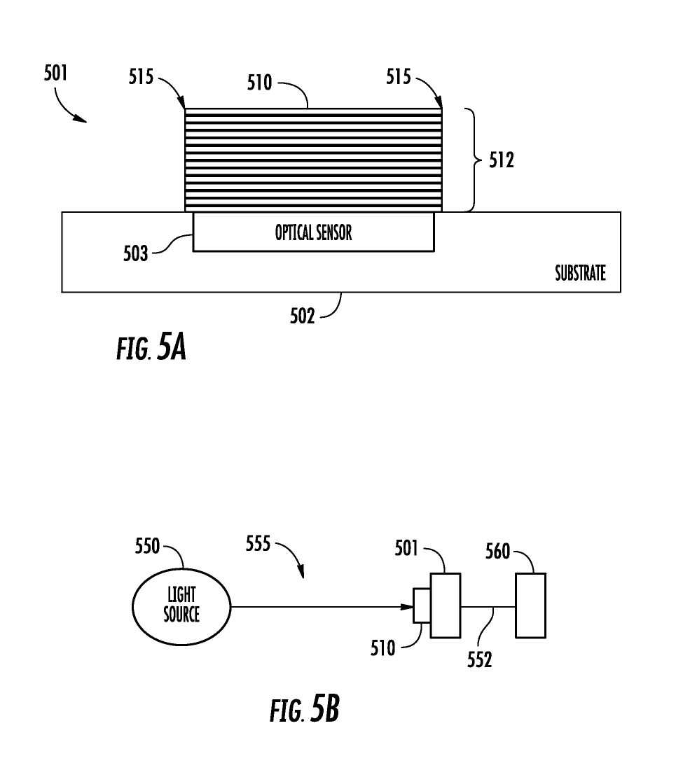

FIG. 4 is a flow chart illustrating a method of one embodiment of the present invention. The method shown in FIG. 4 is applicable to achieving any of the embodiments described above. The method begins at 410 with depositing a first sacrificial layer onto a substrate, the first sacrificial layer having a pattern such that one or more regions of the substrate are exposed through the first sacrificial layer. In one embodiment, the first sacrificial layer is a patterned layer of photoresist applied using masking with a spin or sputtering process. The photoresist material forms a pattern that permits the deposition of a thin film, such as an optical coating, on the regions of the substrate where optical filters are needed. In one embodiment, the sidewalls of the first sacrificial layer are etched to have a negatively angled re-entrant profile. That is, the sidewalls are etched to have a re-entrantly sloped profile, which is wider at the top than at the bottom. In one embodiment, the slope of the sidewalls is less than 88 degrees from a normal (i.e. a vertical 90 degree) slope.

The method proceeds to 420 with depositing a protective layer over at least part of the first sacrificial layer. In one embodiment, the protective layer comprises a second sacrificial layer such as described with respect to FIG. 1. In other alternate embodiments, the protective layer comprises a first optical coating of material such as described with respect to FIGS. 2a-d and 3a-d.

In the case where the protective layer comprises a second sacrificial layer, the material of the protective layer is applied over the first sacrificial layer. In one embodiment, the second sacrificial layer comprises a low temperature deposited oxide or other non-photoresist protective layer as discussed above. The second sacrificial layer performs two functions. First, it thermally shields the first sacrificial layer during subsequent application of the optical coating, providing sufficient thermal budget so that the first sacrificial layer will maintain its profile when the optical coating is applied. Second, it permits further lateral undercutting of the first sacrificial layer (described in block 430 below) prior to application of the optical coating. In one embodiment, after the second sacrificial layer is applied, a masking layer is applied and a pattern is etched into the masking layer to expose the region of the substrate onto which the optical coating is applied. This etching also exposes sidewalls of the first sacrificial layer to permit the lateral undercutting.

In the case where the protective layer comprises a first optical coating, the first optical coating is deposited over the first sacrificial layer and over the exposed regions of the substrate. The first optical coating comprises a sufficiently small number of dielectric layers such that when they are applied, the first sacrificial layer does not reach a temperature that will cause it to flow and lose its profile. In one embodiment, the initial layer of optical coating comprises 2-4 layers of dielectric material, each layer on the order of 100 nanometers thick. In addition, the first optical coating is applied to a total thickness that less than the thickness of the first sacrificial layer. For example, in one embodiment the first sacrificial layer comprises a photoresist layer of 1-10 micrometers while the first optical coating is between 200-400 nanometers in thickness. When the profiles of the sidewalls of the first sacrificial layer are provided with a negatively angled re-entrant profile, the sidewalls will remain free from material after depositing the first optical coating. Otherwise, where depositing of the first optical coating results in a thin coating of material on the sidewalls, an ultrasonic rinse or other process, as mentioned above with respect to FIG. 2, can be applied to breakdown and remove the material.

The method proceeds to 430 with partially removing the first sacrificial layer to form at least one gap between the protective layer and the substrate. The lateral undercutting produces an open void or gap that will remain open to expose the sidewalls of the first sacrificial layer even after subsequent optical coatings are applied. In one embodiment, the gap is on the order of a few micron wide.

The method proceeds to 440 with depositing a thin film, such as an optical coating, over the protective layer and the one or more regions of the substrate exposed through the first sacrificial layer, wherein the optical coating deposited over the protective layer is separated by the at least one gap from the optical coating deposited over the one or more regions of the substrate expose through the first sacrificial layer.

The method proceeds to 450 with removing the first sacrificial layer. In one embodiment, an ultrasonic rinse is applied through the gaps to laterally etch and completely remove the first sacrificial layer, in order to “lift-off” the optical coatings present on top of the photoresist. In another embodiment, an etchant or solvent solution is applied which enters into the gaps to attack and destroy the first sacrificial layer. Subsequent layers that were applied on top of, and supported by, the first sacrificial layer will rinse or break away during this part of the process. Optical coatings applied on top of the exposed substrate will remain. For example, layers of optical coatings applied to an optical sensor in the exposed region of the substrate will remain to function as an optical filter for the optical sensor.

The specific compositions and combinations of the multiple dielectric layers that make up the optical coatings and the resulting optical filter will dictate the refraction index the optical filter. Selection of which optical coating materials to use will depend on the wavelengths of light to be filtered.

Because the one or more gaps provide a well defined break between optical coating material deposited over the protective layer and optical coating material deposited directly onto the substrate, the lift-off procedure performed at block 450 will not distort edges of the remaining layers of optical coating that form a optical filter on the substrate. That is, the layers of optical coating that remain on the substrate after removal of the first sacrificial layer remain substantially flat across the optical filter because they have not been deformed by the lift-off process.

FIG. 5A is an illustration of a device 501 having an optical sensor 503 on a substrate 502 equipped with an optical filter 510 of one embodiment of the present invention. The device 500 may be achieved, for example, using any of the embodiments described with respect for FIGS. 1, 2a-2d, 3a-3d and 4, or combinations thereof. Using the techniques described herein, an optical filter 510 for sensor 503 is achieved were the layers of deposited dielectric films 512 forming optical filter 510 are not distorted at the edges 515 of optical filter 510. That is, the dielectric layers 512 forming optical filter 510 are substantially flat and have horizontal surfaces forming undistorted parallel planes with respect to each other across optical filter 510. FIG. 5B is an illustration of device 501 included within a system 500. Light waves 555 are received from a light source 550 (which may be, but is not necessarily part of system 500) at device 501. Device 501 outputs a signal 552 to component 560 (such as a processor, or an analog-to-digital converter, for example) that is at least partially a function of either the wavelength or intensity of light received by sensor 503. As such, the filtering performed on the light by optical filter 510 affects the information provided by signal 552 to component 560.

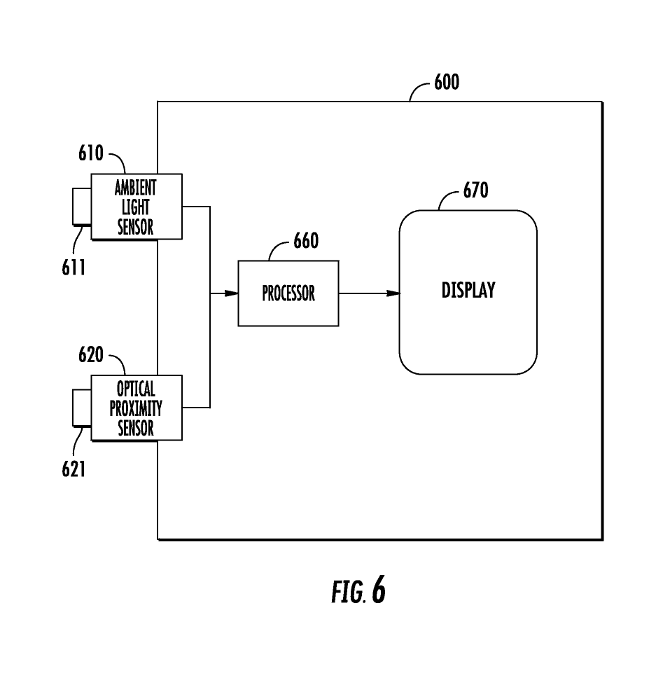

For example, FIG. 6 illustrates a device 600 which displays information produced by a processor 660 to a user via a display 670. In one embodiment, device 600 is a portable electronic device. Also coupled to processor 660 is an ambient light sensor 610 having an optical filter 611 such as described above with respect to optical filter 510 and sensor 503. Because portable electronic device 600 is portable, the ambient light conditions in which portable electronic device 600 is used can vary from complete darkness to bright sunlight. Ambient light sensor 610 provides an indication of the ambient light condition to processor 660, which in turn adjusts the intensity of display 670 either up or down so that the display is readable to the user without the display 670 being too bright for the present conditions so as to consume more power as necessary. Filter 611 being formed as described above with respect to filter 510 of FIG. 5a, comprises dielectric layers 512 having horizontal surfaces that are substantially undistorted parallel planes with respect to each other across optical filter 611, thus providing that the wavelengths of light reaching sensor 610 accurately correspond to those which affect the readability of display 670.

In one alternate embodiment, device 600 further comprises an optical proximity sensor 620 having an optical filter 621 such as described above with respect to optical filter 510 and sensor 503. For example, where device 600 is used as a cellular phone, power resources can be conserved by turning off or otherwise reducing the intensity of display 670 when the device 600 is held to a user's ear. As such, in one embodiment, the processor 660 monitors the output of sensor 620 for changes in light levels that would indicate that ambient light to sensor 620 is being at least partially blocked. When the processor 660 determines that ambient light to sensor 620 is being at least partially blocked, the intensity of display 670 is reduced (potentially completely). In one embodiment, processor 660 makes the determination based on the output signal from sensor 620 dropping below a threshold, or based on a rate of change in the output signal. In yet another embodiment, processor 660 uses the outputs of both sensors 610 and 620 in making the determination. For example, when processor 660 detects a sudden loss of light entering proximity sensor 620, but sensor 610 does not indicate an appreciable change in ambient light conditions, the processor determines that device 600 has been placed proximate to a user's ear and reduces the intensity of display 670. Such an embodiment avoids shutoff of display 670 simply because a nearby light source is suddenly turned off, for example.

Terms of relative position as used in this application are defined based on a plane parallel to the conventional plane or working surface of a wafer or substrate, regardless of the orientation of the wafer or substrate. The term “horizontal” or “lateral” as used in this application is defined as a plane parallel to the conventional plane or working surface of a wafer or substrate, regardless of the orientation of the wafer or substrate. The term “vertical” refers to a direction perpendicular to the horizontal. Terms such as “on,” “side” (as in “sidewall”), “higher,” “lower,” “over,” “top,” and “under” are defined with respect to the conventional plane or working surface being on the top surface of the wafer or substrate, regardless of the orientation of the wafer or substrate.

Although specific embodiments have been illustrated and described herein, it will be appreciated by those of ordinary skill in the art that any arrangement, which is calculated to achieve the same purpose, may be substituted for the specific embodiment shown. Elements of each embodiment described above can be combined with each other to provide still further embodiments. This application is intended to cover any adaptations or variations of the present invention. Therefore, it is manifestly intended that this invention be limited only by the claims and the equivalents thereof.

What is claimed is:

1. A method for pattering a thin film on a substrate, the method comprising:
depositing a first sacrificial layer of photoresist material onto a substrate, the first sacrificial layer having a pattern such that one or more regions of the substrate are exposed through the first sacrificial layer;
depositing a protective layer over at least part of the first sacrificial layer;
partially removing the first sacrificial layer to form at least one gap between the protective layer and the substrate;
depositing an optical coating over the protective layer and the one or more regions of the substrate exposed through the first sacrificial layer, wherein the optical coating deposited over the protective layer is separated by the at least one gap from the optical coating deposited over the one or more regions of the substrate exposed through the first sacrificial layer; and
removing the first sacrificial layer.

2. The method of claim 1, wherein the protective layer comprises a low temperature deposited oxide material.

3. The method of claim 1, wherein depositing the protective layer further comprises depositing the protective layer at a temperature such that the first sacrificial layer maintains its profile.

4. The method of claim 1, wherein a total thickness of the protective layer is less than a thickness of the first sacrificial layer.

5. The method of claim 1, wherein one or more sidewalls of the first sacrificial layer are etched to have a negatively angled re-entrant profile.

6. The method of claim 1, wherein partially removing the first sacrificial layer to form at least one gap between the protective layer and the substrate produces a gap on the order of 1-10 micron wide.

7. The method of claim 1, wherein the optical coating deposited over the one or more regions of the substrate exposed through the first sacrificial layer forms a dielectric mirror.

8. The method of claim 1, wherein depositing the optical coating over the protective layer and the one or more regions of the substrate exposed through the first sacrificial layer further comprises depositing a plurality of dielectric layers, wherein the plurality of dielectric layers have horizontal surfaces forming parallel planes with respect to each other after removal of the first sacrificial layer.

9. The method of claim 8, wherein the plurality of deposited layers have horizontal surfaces that remain as substantially parallel planes at edges of an optical filter formed by the dielectric mirror.

10. The method of claim 1, wherein removing the first sacrificial layer comprises applying an ultrasonic rinse, an etchant, or a solvent solution through the at least one gap to completely undercut the photoresist material of the first sacrificial layer.

11. The method of claim 1, wherein the optical coating is a thin film that forms an optical filter.

12. A method for pattering a thin film on a substrate, the method comprising:
depositing a first sacrificial layer of photoresist material onto a substrate, the first sacrificial layer having a pattern such that one or more regions of the substrate are exposed through the first sacrificial layer;
depositing a protective layer of a first optical coating over the first sacrificial layer and one or more regions of the substrate exposed through the first sacrificial layer.
partially removing the first sacrificial layer to form at least one gap between the protective layer and the substrate;
depositing a second optical coating over the protective layer and the one or more regions of the substrate exposed through the first sacrificial layer, wherein the second optical coating deposited over the protective layer is separated by the at least one gap from the second optical coating as deposited over the one or more regions of the substrate exposed through the first sacrificial layer; and
removing the first sacrificial layer.

13. The method of claim 12, further comprising:
removing a portion of the protective layer to expose at least one sidewall of the first sacrificial layer.

14. The method of claim 12, wherein depositing the protective layer further comprises depositing up to 4 layers of dielectric material, wherein each of the 4 layers is on the order of 100 nanometers in thickness.

15. The method of claim 12, wherein a total thickness of the protective layer is less than a thickness of the first sacrificial layer.

16. The method of claim 12, wherein one or more sidewalls of the first sacrificial layer are etched to have a negatively angled re-entrant profile.

17. The method of claim 12, wherein partially removing the first sacrificial layer to form at least one gap between the protective layer and the substrate produces a gap on the order of 1-10 micron wide.

18. The method of claim 12, wherein the first optical coating and the second optical coating as deposited over the one or more regions of the substrate exposed through the first sacrificial layer forms a dielectric mirror.

19. The method of claim 12, wherein depositing the second optical coating over the protective layer and the one or more regions of the substrate exposed through the first sacrificial layer further comprises depositing a plurality of dielectric layers, wherein the plurality of dielectric layers have horizontal surfaces forming parallel planes with respect to each other after removal of the first sacrificial layer.

20. The method of claim 19, wherein the plurality of deposited layers have horizontal surfaces that remain as substantially parallel planes at edges of an optical filter formed by the dielectric mirror.

21. The method of claim 12, wherein removing the first sacrificial layer comprises applying an ultrasonic rinse, an etchant, or a solvent solution through the at least one gap to completely undercut the photoresist material of the first sacrificial layer.

22. A filter prepared by a process comprising:
forming a sacrificial layer of photoresist material on a substrate;
depositing a protective material layer over the sacrificial layer;
depositing an optical coating comprising layers of dielectric material onto the protective layer and onto an optical sensor device fabricated from the substrate;
wherein the sacrificial layer is undercut to form a gap between the protective material layer and the substrate such that when the optical coating is applied over the protective material layer and the substrate, a break in the optical coating is formed; and
removing the sacrificial layer from the substrate, wherein when the sacrificial layer is removed, a region of the optical coating remains to form an optical filter over the optical sensor device.

23. The sensor of claim 22, wherein the optical filter further comprises a plurality of deposited layers of the dielectric material that have horizontal surfaces forming parallel planes with respect to each other across the optical filter.

24. The sensor of claim 23, wherein the horizontal surfaces of the plurality of deposited layers remain as parallel planes at edges of the optical filter.

25. A filter prepared by a process comprising:
forming a sacrificial layer of photoresist material on a substrate;
depositing a protective material layer of a first optical coating over the sacrificial layer;
depositing a second optical coating comprising layers of dielectric material onto the protective material layer and onto an optical sensor device fabricated from the substrate;
wherein the sacrificial layer is undercut to form a gap between the protective material layer and the substrate such that when the optical coating is applied over the protective material layer and the substrate, a break in the optical coating is formed; and
removing the sacrificial layer from the substrate, wherein when the sacrificial layer is removed, a region of the optical coating remains to form an optical filter over the optical sensor device.

26. The sensor of claim 26, wherein the optical filter further comprises a plurality of deposited layers of the dielectric material that have horizontal surfaces forming parallel planes with respect to each other across the optical filter.

27. The sensor of claim 27, wherein the horizontal surfaces of the plurality of deposited layers remain as parallel planes at edges of the optical filter.

28. The sensor of claim 26, wherein a total thickness of the first optical coating is less than a thickness of the sacrificial layer.

29. An apparatus comprising:
an optical sensor formed on a substrate; and
an optical filter comprising a plurality of layers of dielectric material deposited on the optical sensor such that the plurality of layers of dielectric material have surfaces that form substantially parallel planes with respect to each other across the optical filter.

30. The apparatus of claim 29, wherein the optical filter is prepared by a process comprising:
forming a sacrificial layer of photoresist material on the substrate;
depositing a protective material layer over the sacrificial layer;
depositing an optical coating material onto the sacrificial layer and onto the optical sensor;
wherein the sacrificial layer is undercut to form a gap between the protective material and the substrate such that when the optical coating is applied over the sacrificial layer and the substrate, a break in the optical coating is formed; and
removing the sacrificial layer from the substrate, wherein when the sacrificial layer is removed, a region of the optical coating remains to form the optical filter over the optical sensor device.

31. The apparatus of claim 30, wherein the plurality of deposited layers have horizontal surfaces that remain as parallel planes at edges of the optical filter after removal of the sacrificial layer.

32. A system comprising:
a device comprising:
a substrate having at least one optical sensor formed on a surface thereon; and
an optical filter deposited on the substrate over the optical sensor, the optical filter further comprising a plurality of deposited layers of dielectric material with horizontal surfaces that form substantially parallel planes with respect to each other across the optical filter; and
at least one component that receives an output from the device.

33. The system of claim 32, wherein the horizontal surface of the plurality of deposited layers remain as parallel planes at edges of the optical filter.

34. The system of claim 32, further comprising a display and wherein the at least one component further comprises a processor;
wherein the processor received the output from the device and based on the output adjusts an intensity of the display.

35. The system of claim 32, wherein the device functions as an ambient light sensor and the optical filter is a band pass filter that passes ambient light to the optical sensor.

36. The system of claim 32, wherein the optical filter has a pass band that passes ambient visible light to the optical sensor having wavelengths that correspond to those that affect readability of the display.

37. The system of claim 32, wherein the processor reduces the intensity of the display based on a change in the output from the device that indicates a drop in ambient light reaching the optical sensor.

38. A method for a lift-off process, the method comprising:
depositing a first sacrificial layer of photoresist material onto a substrate, the first sacrificial layer having a pattern such that one or more regions of the substrate are exposed through the first sacrificial layer;
depositing a protective layer of a first optical coating over the first sacrificial layer and one or more regions of the substrate exposed through the first sacrificial layer;
partially removing a portion of the first sacrificial layer to form at least one gap;
depositing a second optical coating over the protective layer and the one or more regions of the substrate exposed through the first sacrificial layer; and
removing the first sacrificial layer.

39. The method of claim 38, wherein depositing the protective layer further comprises depositing up to 4 layers of dielectric material, wherein each of the 4 layers is on the order of 100 nanometers in thickness.

40. The method of claim 38, wherein a total thickness of the protective layer is less than a thickness of the first sacrificial layer.

41. The method of claim 38, further comprising:
removing a portion of the protective layer to expose at least one sidewall of the first sacrificial layer.

42. The method of claim 38, wherein partially removing a portion of the first sacrificial layer further comprises etching one or more sidewalls of the first sacrificial layer to have a negatively angled re-entrant profile.

43. The method of claim 38, wherein partially removing a portion of the first sacrificial layer forms at least one gap between the protective layer and the substrate on the order of 1-10 micron wide.
